(19) United States
(12) Patent Application Publication
(10) Pub. No.: US 2021/0287144 A1
(43) Pub. Date: Sep. 16, 2021

(54) MOBILE TERMINAL, COMPUTER READABLE RECORDING MEDIUM AND WALLET SYSTEM

(71) Applicant: TOYOTA JIDOSHA KABUSHIKI KAISHA, Toyota-shi (JP)

(72) Inventors: Hiroto TOMIDA, Tokyo-to (JP); Tae SUGIMURA, Miyoshi-shi (JP); Ryuta YANAGISAWA, Ichikawa-shi (JP); Takuya TORIU, Tokyo-to (JP); Daisuke KOMIYAMA, Tokyo-to (JP); Zejun MEI, Fujimi-shi (JP); Kazuhiko YAMAGUCHI, Nagoya-shi (JP); Honami MORI, Nagoya-shi (JP)

(73) Assignee: TOYOTA JIDOSHA KABUSHIKI KAISHA, Toyota-shi (JP)

(21) Appl. No.: 17/166,224

(22) Filed: Feb. 3, 2021

(30) Foreign Application Priority Data
Mar. 12, 2020 (JP) 2020-043490

(51) Int. Cl. G06Q 10/02; G06K 19/06; G06Q 50/12

(52) U.S. Cl. CPC G06Q 10/02; G06K 19/06112; G06Q 20/363; G06K 19/06028; G06K 19/06037; G06Q 50/12

(57) ABSTRACT

A mobile terminal includes: a display; and a processor including hardware, the processor being configured to acquire reservation information of a user from a server configured to manage the reservation information at an accommodation facility, generate a code indicating the reservation information, and control the display to display the generated code.

The present application claims priority to and incorporates by reference the entire contents of Japanese Patent Application No. 2020-043490 filed in Japan on Mar. 12, 2020.

### BACKGROUND

The present disclosure relates to a mobile terminal, a computer readable recording medium and a wallet system.

In JP 2019-032749 A, a technique of acquiring reservation information of a user from a server and performing a check-in procedure when an identification code to identify the reservation information of the user is input to a tablet computer provided in certain accommodation facility has been proposed.

### SUMMARY

There is a need for a mobile terminal, a computer readable recording medium and a wallet system that may simplify a check-in procedure at an accommodation facility.

According to one aspect of the present disclosure, there is provided a mobile terminal including: a display; and a processor including hardware, the processor being configured to acquire reservation information of a user from a server configured to manage the reservation information at an accommodation facility, generate a code indicating the reservation information, and control the display to display the generated code.

### BRIEF DESCRIPTION OF THE DRAWINGS

FIG. 1 is a view schematically illustrating a configuration of a wallet system according to an embodiment;

FIG. 2 is a block diagram illustrating details of each component of the wallet system according to the embodiment;

FIG. 3 is view illustrating an example in which reservation information and schedule information of a user are combined and displayed on an operation/display unit of a user terminal in the wallet system according to the embodiment; and

FIG. 4 is a flowchart illustrating an example of a check-in procedure method at an accommodation facility which method is executed by the wallet system according to the embodiment.

### DETAILED DESCRIPTION

A mobile terminal, a computer readable recording medium storing a wallet program and a wallet system according to an embodiment of the present disclosure will be described with reference to the drawings. Note that components in the following embodiment include what may be easily replaced by those skilled in the art or what is substantially the same.

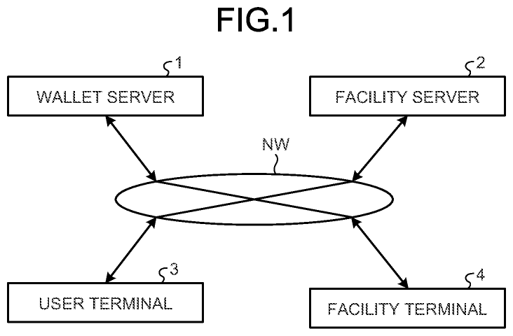

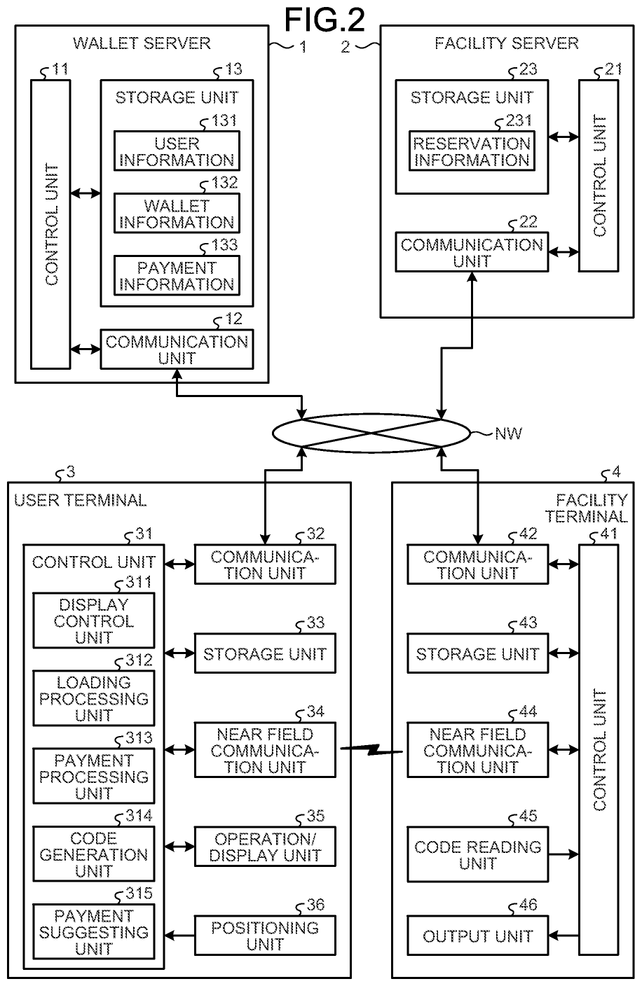

A configuration of the wallet system will be described with reference to FIG. 1 and FIG. 2. As illustrated in FIG. 1, the wallet system includes a wallet server 1, a facility server 2, a user terminal 3, and a facility terminal 4. In the wallet system, the wallet server 1, the facility server 2, the user terminal 3, and the facility terminal 4 are configured to communicate with each other through a network NW. The network NW includes, for example, the Internet, a mobile phone network, and the like. Note that in the drawing, one facility server 2, one user terminal 3, and one facility terminal 4 are illustrated, but they may be provided in plurality.

The wallet server 1 manages the wallet system. The wallet server 1 is realized by a general-purpose computer such as a workstation or a personal computer. Moreover, the wallet server 1 is managed by an administrator (provider) of the wallet system. As illustrated in FIG. 2, the wallet server 1 includes a control unit 11, a communication unit 12, and a storage unit 13.

More specifically, the control unit 11 includes: a processor such as a central processing unit (CPU), a digital signal processor (DSP), a field-programmable gate array (FPGA), and the like; and a memory (main storage unit) such as a random access memory (RAM), a read only memory (ROM), and the like. The control unit 11 realizes a function that meets a predetermined purpose by loading and executing a program, which is stored in the storage unit 13, in a work area of the main storage unit and controlling each configuration unit and the like through execution of the program.

The communication unit 12 includes, for example, a local area network (LAN) interface board, a wireless communication circuit for wireless communication, and the like. The communication unit 12 is connected to the network NW that is a public communication network, such as the Internet. Then, the communication unit 12 communicates with the facility server 2, the user terminal 3, and the facility terminal 4 by being connected to the network NW.

The storage unit 13 includes recording media such as an erasable programmable ROM (EPROM), a hard disk drive (HDD), and a removable medium. Examples of the removable media include a universal serial bus (USB) memory, and disc recording media such as a compact disc (CD), a digital versatile disc (DVD), and a Blu-ray (registered trademark) disc (BD). The storage unit 13 may store an operating

Docket No. PTYA-19721-US,CN

Status: FINAL system (OS), various programs, various tables, various databases, and the like. Moreover, the storage unit 13 stores user information 131, wallet information 132, and payment information 133 of each user of the wallet system.

The user information 131 relates to a user who uses the wallet system. Examples of the user information 131 include a user ID, password, user name, user contact information (such as address, telephone number, and email address), and the like of a user who has registered in advance to use the wallet system. Note that the user ID and password in the user information 131 are used for authentication processing such as a login to the wallet server 1.

The wallet information 132 relates to a wallet (electronic wallet) of the wallet system. The wallet indicates a virtual deposit/withdrawal account of electronic money. The wallet information 132 includes, for example, a user ID, a balance of electronic money, a loading history of the electronic money, a usage history of the electronic money, and the like.

The payment information 133 relates to payment in the wallet system. The payment information 133 includes a user ID, a way of payment used for payment (such as electronic money payment (contactless payment), scan payment, or code payment), a payment history, and the like.

The facility server 2 manages reservation information of accommodation facilities (such as hotel, inn, and the like) that provide accommodation services. This facility server 2 is realized by a general-purpose computer such as a workstation or a personal computer. Moreover, for example, the facility server 2 may be managed by an administrator of each accommodation facility, or may be managed by an administrator of a travel reservation site or the like operated by contracts with a plurality of accommodation facilities.

As illustrated in FIG. 2, the facility server 2 includes a control unit (first processor) 21, a communication unit 22, and a storage unit 23. The control unit 21, the communication unit 22, and the storage unit 23 are physically similar to the control unit 11, the communication unit 12, and the storage unit 13. Reservation information 231 is stored in the storage unit 23.

The reservation information 231 relates to a reservation at an accommodation facility by a user. The reservation information 231 includes, for example, a name, an address, a telephone number, an e-mail address, an accommodation facility name, a period of a stay, the number of guests, a room type, whether an accommodation fee is paid, and the like of the user. More specifically, this reservation information 231 is generated based on an accommodation reservation by the user. The accommodation reservation by the user includes, for example, an online reservation through an official website operated by an accommodation facility, an online reservation through a travel reservation site operated on consignment from a plurality of accommodation facilities, a reservation by a telephone or fax, and the like. Moreover, the reservation information 231 may be updated based on information input from the facility terminal 4 (such as information related to a payment of an accommodation fee).

For example, when a user makes a reservation by an online reservation through an official website of an accommodation facility, the user accesses a reservation page of the official website through the user terminal 3. Then, when information corresponding to the reservation information 231 is input to the reservation page, a reservation request including these pieces of information is output from the user terminal 3 to the facility server 2. In response to this, the control unit 21 of the facility server 2 generates the reservation information 231 and performs storing thereof into the storage unit 23.

The user terminal 3 is a mobile terminal used by a user. The user may book an accommodation facility and pay an accommodation fee through the user terminal 3. Examples of the user terminal 3 include a smartphone, a mobile phone, a tablet terminal, a wearable computer, and the like owned by the user.

As illustrated in FIG. 2, the user terminal 3 includes a control unit (second processor) 31, a communication unit 32, a storage unit 33, a near field communication unit 34, an operation/display unit (display) 35, and a positioning unit 36. The control unit 31, the communication unit 32, and the storage unit 33 are physically similar to the control unit 11, the communication unit 12, and the storage unit 13. The control unit 31 functions as a display control unit 311, a loading processing unit 312, a payment processing unit 313, a code generation unit 314, and a payment suggesting unit 315 through execution of a program.

The display control unit 311 controls display contents on the operation/display unit 35. The display control unit 311 controls the operation/display unit 35 to display predetermined information based on an operation (such as touch operation or flick operation) by the user. Examples of the information displayed on the operation/display unit 35 by the display control unit 311 include, for example, a member registration screen of when a user registers as a member of the wallet system, a login screen of when a login to the wallet system is performed, a loading screen of when electronic money is loaded to (put on) a wallet, a payment screen of when a payment is performed, a schedule registration screen for a user to register schedule information, a reservation screen of an official website of an accommodation facility, a reservation screen of a travel reservation site, and the like.

Moreover, the display control unit 311 controls the operation/display unit 35 to display a code generated by the code generation unit 314. Here, the “code” is an image to identify a reservation at an accommodation facility by a user, and more specifically indicates a bar code or a two-dimensional code (such as QR code (registered trademark)).

The code includes information that is able to identify the reservation at the accommodation facility by the user and that matches a guest ledger format of the accommodation facility that is a place of the stay. This code preferably includes at least a name of the user who makes the accommodation reservation, a name of the accommodation facility, and a period of the stay. Note that the code may include all pieces of information corresponding to the reservation information 231 stored in the storage unit 23, or only a piece of information that may identify the reservation information 231 of the user (such as reservation number).

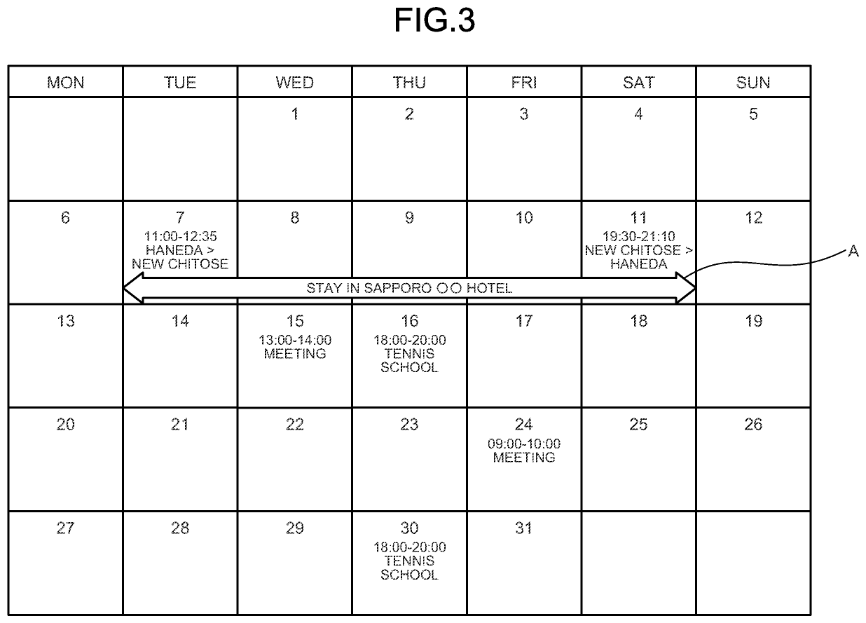

The display control unit 311 may control the operation/display unit 35 to display the reservation information 231 at the accommodation facility and schedule information, which is previously registered by the user, in combination with each other. In this case, the display control unit 311 acquires, through the network NW, the reservation information 231 of the user which information is stored in the storage unit 23 of the facility server 2 and the schedule information of the user which information is stored in the storage unit 33. Then, the display control unit 311 controls the operation/display unit 35 to display a schedule table (calendar) in which pieces of information included in the reservation information 231 and other pieces of schedule information are combined, for example, as illustrated in FIG. 3. Note that in the drawing, as illustrated in a part A, only a name of an accommodation facility (Sapporo oo hotel) and a period of a stay (7 to 11) among the pieces of information included in the reservation information 231 are combined with the schedule information. However, other pieces of information may be combined. That is, a method of combining the reservation information 231 and the schedule information of the user is not limited to the example in the drawing.

The loading processing unit 312 loads electronic money to the wallet. The loading processing unit 312 outputs, to the wallet server 1, a loading request for causing a previously-set way of loading to load electronic money to the wallet. Note that the “way of loading” indicates a way to put electronic money on a wallet that is a virtual deposit/withdrawal account. Examples of the way of loading include a bank account, a credit card, and the like.

The control unit 11 of the wallet server 1 that acquires the loading request from the loading processing unit 312 increases the balance of the electronic money in the wallet based on loaded amount information included in the loading request. That is, the control unit 11 updates the wallet information 132 stored in the storage unit 13 according to an increased amount of the balance of the electronic money in the wallet.

The payment processing unit 313 pays accommodation expenses at the accommodation facility. The payment processing unit 313 outputs, to the facility terminal 4, a payment request for causing a payment to be made by utilization of any of a plurality of previously-set ways of payment (electronic money payment, scan payment, and code payment), for example, with electronic money loaded to a wallet.

For example, in a case of making an electronic money payment, the payment processing unit 313 outputs the payment request to the facility terminal 4 through the near field communication unit 34. Moreover, in a case of making a scan payment, the payment processing unit 313 outputs the payment request to the facility terminal 4 by reading, with a camera or the like of the user terminal 3, a bar code or two-dimensional code (such as QR code (registered trademark)) displayed on a display unit of the facility terminal 4. Moreover, in a case of making a code payment, the payment processing unit 313 outputs the payment request to the facility terminal 4 by causing a code reading unit 45 of the facility terminal 4 to read a bar code or two-dimensional code displayed on the operation/display unit 35 of the user terminal 3.

A control unit 41 of the facility terminal 4 that acquires the payment request from the user terminal 3 outputs a payment request including a payment amount (accommodation fee) to the wallet server 1 through the network NW. The control unit 11 of the wallet server 1 that acquires the payment request from the facility terminal 4 decreases a balance of the electronic money in the wallet of the user based on the payment amount information included in the payment request. That is, the control unit 11 updates the wallet information 132 and the payment information 133 stored in the storage unit 13 according to a decreased amount of the balance of the electronic money in the wallet. Then, the control unit 11 outputs the updated wallet information 132 and payment information 133 to the user terminal 3. Furthermore, the control unit 11 outputs information indicating that the payment is completed (hereinafter, referred to as “payment completion information”) to the facility server 2.

Here, all of the electronic money payment, scan payment, and code payment described above assume a case where the user makes a direct payment (face-to-face payment) at the accommodation facility. However, for example, it is also possible to make a payment with electronic money, which is loaded to the wallet, on a reservation page of an official website of the accommodation facility or a travel reservation site (non-face-to-face payment). In this case, the payment processing unit 313 outputs the payment request to the facility server 2 through the network NW.

Subsequently, the control unit 21 of the facility server 2 outputs a payment request including a payment amount to the wallet server 1 through the network NW. The control unit 11 of the wallet server 1 that acquires the payment request from the facility server 2 decreases the balance of the electronic money in the wallet of the user based on the payment amount information included in the payment request. That is, the control unit 11 updates the wallet information 132 and the payment information 133 stored in the storage unit 13 according to a decreased amount of the balance of the electronic money in the wallet. Then, the control unit 11 outputs the updated wallet information 132 and payment information 133 to the user terminal 3, and outputs payment completion information to the facility server 2.

Note that the payment processing unit 313 may also make a payment with a way of payment other than the balance of the electronic money in the wallet (such as pre-registered bank account or credit card) on the reservation page of the official website of the accommodation facility or the travel reservation site, for example.

The code generation unit 314 generates a code (bar code or two-dimensional code) indicating the reservation information 231 of the user. The code generation unit 314 acquires the reservation information 231 stored in the storage unit 23 of the facility server 2 and generates the code.

Here, the code generation unit 314 may generate a code only when the accommodation fee is paid in advance by the user. In this case, the code generation unit 314 determines whether the payment to the accommodation facility is completed by the user based on the reservation information 231 acquired from the facility server 2. That is, the code generation unit 314 determines whether the reservation information 231 includes information indicating that the accommodation fee is already paid. Then, the code generation unit 314 generates a code in a case of determining that the payment to the accommodation facility is completed. In such a manner, since a code is generated only when the accommodation fee is paid in advance, a side of the accommodation facility does not need to confirm with the user whether the accommodation fee is paid. Thus, the check-in procedure may be further simplified.

Moreover, the code generation unit 314 may automatically generate a code when detecting that the user arrives at the accommodation facility. In this case, the code generation unit 314 determines whether the user arrives at the accommodation facility based on positional information of the user terminal 3 which information is detected by the positioning unit 36. Then, the code generation unit 314 generates a code in a case of determining that the user arrives at the accommodation facility. In such a manner, since a code is automatically generated when an arrival of the user at the accommodation facility is detected, the check-in procedure may be seamlessly performed at the arrival at the accommodation facility.

The payment suggesting unit 315 suggests the user to pay the accommodation fee. The payment suggesting unit 315 acquires the reservation information 231 stored in the storage unit 23 of the facility server 2, and determines

Docket No. PTYA-19721-US,CN

Status: FINAL whether the payment to the accommodation facility is completed by the user based on the reservation information 231. That is, the payment suggesting unit 315 determines whether the reservation information 231 includes information indicating that the accommodation fee is already paid. Then, in a case of determining that the payment to the accommodation facility is not completed, the payment suggesting unit 315 controls the operation/display unit 35 to display a way of payment that may be used for the payment to the accommodation facility among a plurality of previously-set ways of payment.

Here, the “plurality of ways of payment” indicates, for example, an electronic money payment, scan payment, and code payment in a case of a face-to-face payment, and indicates, for example, an electronic money payment, bank account payment, credit card payment, and the like in a case of a non-face-to-face payment. In such a manner, since a payment of an accommodation fee is suggested when the accommodation fee is not paid in advance, the side of the accommodation facility does not need to confirm with the user whether the accommodation fee is paid. Thus, the check-in procedure may be further simplified.

Note that in a case of determining that the payment to the accommodation facility is not completed, the payment suggesting unit 315 may control the operation/display unit 35 to display a way of payment that is optimal for the payment to the accommodation facility among the plurality of previously-set ways of payment. In this case, the optimal way of payment may be determined depending on whether there is a campaign for each way of payment.

The storage unit 33 stores data of various screens displayed on the operation/display unit 35 by the display control unit 311. Moreover, in the storage unit 33, user information 131, wallet information 132, payment information 133, a current position of the user terminal 3 which position is acquired by the positioning unit 36, schedule information previously registered by the user, and the like are stored when necessary.

The near field communication unit 34 has a communication function based on a standard such as near field radio communication (NFC), Bluetooth (registered trademark) low energy (BLE), or infrared data association (IrDA). The user terminal 3 performs near field communication with the facility terminal 4 through the near field communication unit 34, for example, when making an electronic money payment.

The operation/display unit 35 includes, for example, a touch panel display, and has an input function of receiving an operation by a finger of a user, a pen, or the like, and a display function of displaying various kinds of information under the control by the display control unit 311.

The positioning unit 36 receives a radio wave from a global positioning system (GPS) satellite and detects positional information of the user terminal 3. Then, the control unit 31 stores, in the storage unit 33, the positional information of the user terminal 3 which information is detected by the positioning unit 36.

The facility terminal 4 is provided, for example, at a front desk or the like of an accommodation facility. The user performs a check-in procedure through the facility terminal 4. Examples of the facility terminal 4 include a tablet terminal, a personal computer, and the like.

As illustrated in FIG. 2, the facility terminal 4 includes a control unit 41, a communication unit 42, a storage unit 43, a near field communication unit 44, a code reading unit 45, and an output unit 46. The control unit 41, the communication unit 42, the storage unit 43, and the near field communication unit 44 are physically similar to the control unit 11, the communication unit 12, the storage unit 13, and the near field communication unit 34.

The code reading unit 45 performs a check-in procedure and an accommodation fee payment procedure of the user by reading a code (bar code or two-dimensional code) displayed on the operation/display unit 35 of the user terminal 3. Note that the code reading unit 45 may output the information read from the user terminal 3 to a side of the facility server 2.

The output unit 46 is to output the reservation information 231 of the user and is, for example, a printer provided at the front desk or the like of the accommodation facility. When the user checks in to the accommodation facility, the output unit 46 outputs, on a paper medium, the reservation information 231 corresponding to the code read by the code reading unit 45. Since corresponding to a guest ledger format of the accommodation facility, the output reservation information 231 is saved as it is as a guest list.

The output unit 46 may automatically output the reservation information 231 when the code reading unit 45 reads the code displayed on the user terminal 3, or may output the reservation information 231 based on a separate operation (such as pressing a print button) by a staff of the accommodation facility.

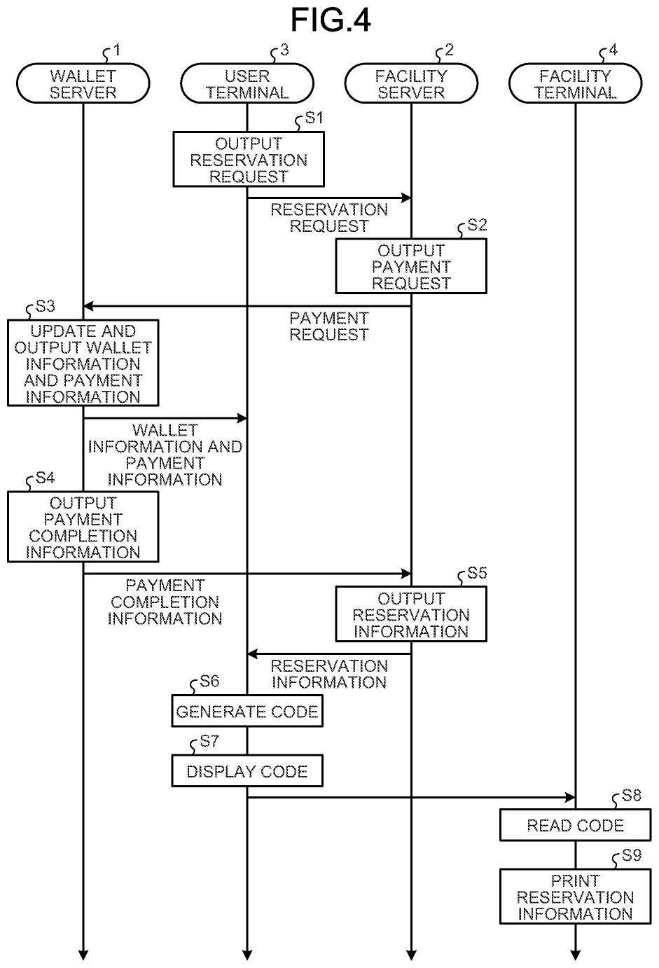

In the following, an example of a check-in procedure method at an accommodation facility which method is executed by the wallet system according to the embodiment will be described with reference to FIG. 4. Note that in the following, a description will be made on the assumption of a situation in which a user makes an accommodation reservation and accommodation fee payment on an official website of an accommodation facility and then performs a check-in procedure at the accommodation facility.

First, a control unit 31 of a user terminal 3 outputs a reservation request for an accommodation facility to a facility server 2 (Step S1). Subsequently, a control unit 21 of the facility server 2 outputs a payment request including a payment amount to a wallet server 1 (Step S2).

Subsequently, a control unit 11 of the wallet server 1 updates wallet information 132 and payment information 133 of the user based on the payment amount included in the payment request, and performs an output thereof to the user terminal 3 (Step S3). Subsequently, the control unit 11 outputs payment completion information to the facility server 2 (Step S4). Subsequently, the control unit 21 outputs reservation information 231 of the user to the user terminal 3 (Step S5).

Subsequently, a code generation unit 314 of the user terminal 3 generates a code based on the reservation information 231 of the user (Step S6), and controls an operation/display unit 35 to display the code (Step S7).

Subsequently, a code reading unit 45 of a facility terminal 4 reads the code displayed on the user terminal 3 (Step S8). Subsequently, an output unit 46 of the facility terminal 4 prints the reservation information 231 of the user (Step S9), and this flow is completed.

As described above, according to a mobile terminal, wallet program, and wallet system of an embodiment, a check-in procedure may be performed only by displaying of a code at an accommodation facility. Thus, the check-in procedure at the accommodation facility may be simplified. Moreover, according to the mobile terminal, wallet program, and wallet system of the embodiment, it is not necessary to handwrite a hotel register at the time of the check-in procedure. Thus, complexity of the check-in procedure is resolved.

For example, the mobile terminal, wallet program, and wallet system according to the embodiment may be applied not only to check-in procedures at accommodation facilities, but also to reservation procedures at other facilities (such as amusement park, aquarium, zoo, museum, and the like), and reservation procedures at other events (such as music festival and gourmet festival).

According to the present disclosure, a check-in procedure at an accommodation facility may be simplified.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A mobile terminal comprising:
a display; and
a processor comprising hardware, the processor being configured to
acquire reservation information of a user from a server configured to manage the reservation information at an accommodation facility,
generate a code indicating the reservation information, and
control the display to display the generated code.

2. The mobile terminal according to claim 1, wherein the code includes at least a name of a user who books the accommodation facility, a name of the accommodation facility, and a period of a stay.

3. The mobile terminal according to claim 1, wherein the code is represented by a bar code or a two-dimensional code.

4. The mobile terminal according to claim 1, wherein the processor is configured to:
determine whether a payment to the accommodation facility has been completed by the user based on the reservation information acquired from the server; and generate the code in a case of determining that the payment to the accommodation facility has been completed.

5. The mobile terminal according to claim 1, wherein the processor is configured to:
determine whether a payment to the accommodation facility has been completed by the user based on the reservation information acquired from the server; and
control the display to display an available way of payment to the accommodation facility among a plurality of previously-set ways of payment in a case of determining that the payment to the accommodation facility has not been completed.

6. The mobile terminal according to claim 1, wherein the processor is configured to control the display to display the reservation information and schedule information registered by the user in advance, in combination with each other.

7. The mobile terminal according to claim 1, wherein the processor is configured to generate the code in a case of detecting that the user arrives at the accommodation facility.

8. A non-transitory computer-readable recording medium on which an executable program is recorded, the program causing a processor of a computer to execute:
acquiring reservation information of a user from a server configured to manage reservation information at an accommodation facility;
generating a code indicating the reservation information; and
controlling a display of a mobile terminal to display the generated code.

9. The non-transitory computer-readable recording medium according to claim 8, wherein the code includes at least a name of a user who books the accommodation facility, a name of the accommodation facility, and a period of a stay.

10. The non-transitory computer-readable recording medium according to claim 8, wherein the code is a bar code or a two-dimensional code.

11. The non-transitory computer-readable recording medium according to claim 8, wherein the program causes the processor to execute:
determining whether a payment to the accommodation facility has been completed by the user based on the reservation information acquired from the server; and
generating the code in a case of determining that the payment to the accommodation facility has been completed.

12. The non-transitory computer-readable recording medium according to claim 8, wherein the program causes the processor to execute:
determining whether a payment to the accommodation facility has been completed by the user based on the reservation information acquired from the server; and
controlling the display to display an available way of payment to the accommodation facility among a plurality of previously-set ways of payment in a case of determining that the payment to the accommodation facility has not been completed.

13. The non-transitory computer-readable recording medium according to claim 8, wherein the program causes the processor to execute controlling the display to display the reservation information and schedule information registered by the user in advance, in combination with each other.

14. The non-transitory computer-readable recording medium according to claim 8, wherein the program causes the processor to execute generating the code in a case of detecting that the user arrives at the accommodation facility.

15. A wallet system comprising:
a server comprising
a first processor comprising hardware, the first processor being configured to
manage reservation information at an accommodation facility, and
output reservation information of a user to a mobile terminal; and
a mobile terminal comprising
a display, and
a second processor comprising hardware, the second processor being configured to
acquire the reservation information of the user from the server,
generate a code indicating the reservation information, and
control the display to display the generated code.

16. The wallet system according to claim 15, wherein the code includes at least a name of a user who books the accommodation facility, a name of the accommodation facility, and a period of a stay.

17. The wallet system according to claim 15, wherein the code is represented by a bar code or a two-dimensional code.

18. The wallet system according to claim 15, wherein the second processor is configured to:
determine whether a payment to the accommodation facility has been completed by the user based on the reservation information acquired from the server; and
generate the code in a case of determining that the payment to the accommodation facility has been completed.

19. The wallet system according to claim 15, wherein the second processor is configured to:
determine whether a payment to the accommodation facility has been completed by the user based on the reservation information acquired from the server; and
control the display to display an available way of payment to the accommodation facility among a plurality of previously-set ways of payment in a case of determining that the payment to the accommodation facility has not been completed.

20. The wallet system according to claim 15, wherein the second processor is configured to control the display to display the reservation information and schedule information registered by the user in advance, in combination with each other.
